(19) United States
(12) Patent Application Publication
(10) Pub. No.: US 2005/0266147 A1
(43) Pub. Date: Dec. 1, 2005

(54) Method for detecting fiberization of vegetable proteins

(75) Inventors: Gang Yao, Columbia, MO (US); Keshun Liu, Ballwin, MO (US); Fu-Hung Hsieh, Columbia, MO (US)

Correspondence Address: Jingxi Chu, 475 McReynolds Hall, Columbia, MO, 65211-2015, US

(73) Assignee: Curators of the University of Missouri Office of Technology & Special Projects, Columbia, MO (US)

(21) Appl. No.: 11/135,198

(22) Filed: May 23, 2005

Related U.S. Application Data
(60) Provisional application No. 60/573,601, filed on May 21, 2004.

(51) Int. Cl. A23J 1/00

(52) U.S. Cl. 426/656

(57) ABSTRACT

Methods for determining the degrees of fiber formation of textured vegetable proteins are provided. One inventive method based on fluorescence polarization technology comprises selecting a sample or a section thereof, using fluorescence polarization spectroscopy to detect P-value or Anisotropy Index of the sample, and obtaining the degree of fiber formation by comparing the P-value or Anisotropy Index to a pre-generated database collating P values or Anisotropy Index with degrees of fiber formation. Another inventive method based on image processing technique comprises preparing a sample to reveal its fibrous structures, obtaining an original image of the sample, applying edge detection to the original image to produce a second binary image with enhanced contrast, performing Hough transform on the second image to extract line information and generate a third image; defining region of interest on the third image; calculating the degree of fiber formation though analysis of the region of interest. The invention also combines the aforesaid methods to enable the automated and real-time determination of the degree of fiber formation of textured vegetable protein during a production line.

This application claims the benefit of U.S. Provisional Application No. 60/573,601, filed on May 21, 2004.

### FIELD OF THE INVENTION

The present invention relates to a method evaluating textural properties of textured vegetable proteins, and more particularly, to determine the degree of fiber formation in meat analogs using fluorescence polarization spectroscopy and image processing technique.

### BACKGROUND OF THE INVENTION

Vegetable proteins texturized into fibrous meat analogs have played an increasingly important role in meeting the dietary requirements of proteins. Textural properties of the meat analogs, such as, hardness, springiness, and fiber formation, are important for their end uses and consumer acceptance. Currently, besides visual examination and sensory evaluation, very few instrumental devices have been used to quantitatively characterize the textural properties or assess effects of processing variables on the final products.

One of the existing methods uses a texture-measuring machine to measure textural properties, but only in terms of hardness, gumminess, and springiness, which do not characterize the degree of fiber formation of meat analogs. Another existing instrumental measurement is scanning electron microscopy to determine the microstructure of a meat analog (Breene, 1975). To evaluate the fiber formation, the only existing method is visual inspections, during which the sample usually needs to be peeled or dissected in order to better reveal the fibrous structure. In addition, visual inspections are subjective and do not provide a numeric index for accurate and convenient comparison among samples or different productions.

Therefore, there is an urgent need to develop a new technique that can measure the degree of fiber formation of a meat analog objectively and provide a numeric index for quality evaluation and comparison. There is also a need to develop a non-destructive (non-invasive) technique to determine the degree of fiber formation of a meat analog. There is yet another need to develop a technique that can measure degree of fiberization under automate and real-time situations, especially for meat analog productions.

### SUMMARY OF THE INVENTION

It is an object of the present invention to develop a new non-destructive and objective method for determining fiber formation of a meat analog based on fluorescence polarization spectroscopy technology.

Another object is to develop an objective method for determination the degree of fiber formation and providing a numeric index based on image processing technique.

Yet another object is to develop a non-destructive, objective, and automate method to determine fiber formation of a meat analog by analysis and coordinating fluorescence polarization data with the digital imaging database.

The non-destructive inventive method based on fluorescence polarization spectroscopy technology comprises the steps of (1) selecting a sample or a section of a target meat analog, (2) measuring the polarization properties of the sample by using fluorescence polarization spectroscopy, and (3) determining the degree of fiber formation of the sample by comparing the polarization measurements with a pre-generated database collating polarization properties with degrees of fiber formation of the target meat analog.

Another inventive method based on image processing comprises the steps of (1) preparing a sample of a target meat analog to reveal its fibrous structures, (2) obtaining an original image of the sample, (3) applying edge detection to the original image to product a second image with enhanced contrast over the original image, (4) performing Hough transform to extract line information of the second image and generate a third image, (5) defining a region of interest (ROI) within the third image , and (6) calculating the fiber index (FI, i.e. degree of fiber formation) via analysis of the relative standard deviation of the ROI.

The present invention is also directed to a measuring system for detecting the fiber formation of a meet analog. Furthermore, the invention also provides an automated system by installation of one or multiple fluorescence polarization spectrometers along the meet analog production lines.

### BRIEF DESCRIPTION OF THE DRAWINGS

FIG. 1 is a schematic diagram of a fluorescence polarization spectrometer.

FIG. 2 is a schematic diagram of an automated fluorescence polarization measuring system.

FIG. 3A is the digital image of extruded protein products at 60.11% moisture.

FIG. 3B is the digital image of extruded protein products at 66.78% moisture.

FIG. 3C is the digital image of extruded protein products at 72.12% moisture.

FIG. 4A shows the degrees of polarization of samples collected at various moisture contents.

FIG. 4B shows the anisotropic index of samples collected at various moisture contents.

FIG. 5A is the digital image of proteinaceous sample collected in Zone 1.

FIG. 5B is the digital image of proteinaceous sample collected in Zone 2.

FIG. 5C is the digital image of proteinaceous sample collected in Zone 3.

FIG. 5D is the digital image of proteinaceous sample collected in Zone 4.

FIG. 5E is the digital image of proteinaceous sample collected in Zone 5.

FIG. 5F is the digital image of proteinaceous sample collected in Die.

FIG. 6A shows the degrees of polarization of samples obtained from a deed-stop operation of extrusion at 60.11% moisture content.

FIG. 6B shows the anisotropic index of samples obtained from a dead-stop operation of extrusion at 60.11% moisture content.

FIG. 7 shows different regions defined in ROI during image processing.

FIG. 8 shows different stages of image processing algorithm applied on Sample A and B.

FIGS. 9A-9I are digital images (original images) of proteinaceous samples.

FIG. 10 shows correlation of fluorescence polarization index and fiber index.

FIG. 11 shows correlation coefficients obtained with different threshold values applied on edge detected original image (second image).

### DETAILED DESCRIPTION OF THE INVENTION

One of the inventive methods employs the fluorescence polarization spectroscopy technology and derives the information on fiber formation from fluorescence polarization measurements of meet analogs. Although fluorescence spectroscopy based techniques have been used in food sciences prior to the present invention (Swatland H. J., 1987, Measurement of the gristle content in beef by macroscopic ultraviolet fluorimetry. J Anim Sci 65: 158-64; Wold J. P., et al., 1999, Quantification of connective issue (hydrozyproline) in ground beef by autofluorescence spectrocscopy, J. Food Sci 64: 377-85; Defour E., et al., 2001, Delineation of the structure of soft cheeses at the molecular level by fluorescence spectroscopy—relationship with texture. Int Dairy J 11: 465-73; Skjervold P. O., et al., 2003. Development of intrinsic fluorescence multispectral imagery specific for fat, connective tissue, and myofibers in meet. J. Food Sci 68: 1161-68), the optical polarization properties have been seldom considered as a fluorescence measurement for food quality assessments. In the few cases that the polarization properties were measured, the studies were limited to the orientation of green fluorescence protein (Inoue S., et al., 2002, Fluorescence polarization of green fluorescence protein. Biophysics 99(7): 4272-77) or the structural changes at the molecular levels in solid corn meal samples (Gibson S. M., et al., 1989, An assay of molecular mobility in solid corn meal by front-face anisotropy. Cereal Chem 66(4): 310-13).

The present invention is first to employ fluorescence polarization properties in assessing the qualities of a meat analog, particularly the degrees of fiber formation. Based on fluorescence polarization theory, when a polarized light excites the fluorescence substances in a sample, the polarization of the fluorescence light emitted depends on the excited dipoles in the sample. For samples with structure orientation preference, if the excitation polarization is aligned with the preferred structure orientation, then the fluorescence emission light will have a dominant polarization orientation with relatively strong intensity; on the other hand, if the excitation polarization is perpendicular to the preferred structure orientation, then the intensity of the fluorescence emission light will be relatively weak. For samples with no structure orientation preference, the fluorescence emission light will have randomized polarization direction, i.e. non-polarization.

The teaching of the invention reasons that the fluorescence emission light will be highly polarized (with a dominant polarization orientation and high intensity) for fibrous meat analog samples that have high levels of structure orientation preference, i.e. high degrees of fiber formation, if the excitation polarization is aligned with the samples' fiber orientation. For meat analog samples with no or low levels of structure orientation preference, i.e., none or poor fiber formation, the fluorescence emission light will be non-polarized.

The invention observes that during an extrusion process, especially high moisture extrusion, to produce a meat analog, the fiber orientation of the resulting product, if there is fiber formation, is predominately aligned with the extrudate moving direction in the long cooling die. Thus, to test meat analogs produced by extrusion, the excitation polarization can be considered aligning with a sample's fiber orientation when the excitation polarization is aligned with the extrudate moving direction in the long cooling die.

The teaching of the invention, therefore, concludes that the polarization properties (such as, degree of polarization and anisotropy index) can indicate the relative weight of structured components in a sample. In cases of meat analogs, the polarization properties of a sample can indicate the degrees of fiber formation. In addition, the invention teaches that for the meat analogs produced by extrusion, the best results will be achieved when the polarization directions of the excitation lights closely aligned with the extrudate moving direction.

The invention further discloses that the inventive method based on fluorescence polarization technology comprises the steps of (1) selecting a sample of a meat analog, (2) using fluorescence polarization spectroscopy to measure the polarization property of the sample, and (3) determining the degree of fiber formation of the sample by comparing the resulting measurement with a pre-generated database collating polarization properties with degrees of fiber formation of the meat analog.

According to the teaching of the invention, one of the polarization properties, the degree of polarization (P value), of a meat analog sample can be measured, in the following steps:
1) illuminating at least a portion of the sample with light of a first wavelength via a means for polarizing light (P1);
2) measuring a first intensity (I₉₀) of fluorescence emitted at a second wavelength from the sample via a means for selecting a polarized fluorescence emission light for detection (P2), when P2 is at 90° with P1;
3) measuring a second intensity (I₀) of fluorescence emitted at the second wavelength via P2, when P2 is at 0° with P1;
4) calculating the degree of polarization (P) as:

$$P = \frac{\vert {I}_{0} - {I}_{90} \vert}{{I}_{0} + {I}_{90}} \qquad ( 1 )$$

Two intensity measurements are needed to calculate the P value. I₉₀ is the fluorescence intensity measured when P2 is at 90° with P1, and I₀ is the fluorescence intensity measured when P2 is at 0° with P1. In other words, two intensities are measured when the polarization directions of the two emission lights are at about 90° relative geometry.

When a sample fiber's orientation is closely aligned with the P1 direction, a higher P value will be obtained. During a high moisture extrusion, the sample's fiber orientation is always aligned with the extrudate moving direction in the long cooling die. Therefore, when P1 is adjusted to achieve the approximate parallel with the extrudate moving direction, the sample is considered as “mounted” with its fiber's orientation aligned with the P1. When determining P value of a meat analog sample, to achieve the relatively high sensitivity, the P1 is recommended to be adjusted to the approximate parallel position with the extrudate moving direction.

According to the teaching of the invention, another polarization property, the Anisotropy Index (N index), can also be used to determine the degree of fiber formation of meat analogs. The inventive method for detecting the anisotropy index of a meat analog sample comprises the following steps:
1) illuminating at least a portion of the sample with light of a first wavelength via a means for polarizing light (P1) at a first angle (assigned as 0°);
2) measuring a first intensity (I_{90,0}) of fluorescence emitted at a second wavelength from the sample via a means for selecting a polarized fluorescence emission light (P2), when P2 is at 90° with P1;
3) measuring a second intensity (I_{0,0}) of fluorescence emitted at the second wavelength via P2, when P2 is at 0° with P1;
4) calculating the degree of polarization (P₀) at the first angle using the equation (1);
5) illuminating at least a portion of the sample with light of the first wavelength via P1 at a second angle which is perpendicular (90°) to the first angle;
6) measuring a third intensity (I_{90,90}) of fluorescence emitted at the second wavelength via P2, when P2 is at 90° with P1;
7) measuring a fourth intensity (I_{0,90}) of fluorescence emitted at the second wavelength via P2, when P2 is at 0° with P1; and
8) calculating the degree of polarization (P₉₀) at the second angle using the equation (1);
9) calculating the anisotropy index (N) as:

$$N = \frac{\vert {P}_{90} - {P}_{0} \vert}{( {P}_{90} + {P}_{0} ) / 2} \qquad ( 2 )$$

Two P values are needed to determine the N index. P₉₀ is the polarization degree measured with the P1 at 90° with the sample fiber orientation, and P₀ is the polarization degree measured with P1 at 0°. Between the two measurements, the polarization directions of excitation light have been rotated by 90°. In other words, two P values are measured with polarization direction of the excitation light parallel and perpendicular to the sample's fiber orientation. To achieve relative high sensitivity, P1 is recommended to be adjusted first parallel, then perpendicular, to the extrudate moving direction.

According to the teaching of the invention, when a meat analog sample is homogeneous and has a dominant structural orientation, it will have a high degree of polarization and a high anisotropy index. If the sample is homogeneous and has no dominant structural orientation, it will have a small polarization degree and a small anisotropy index. If the sample is inhomogeneous and has no dominant structural orientation, it may have a moderate polarization degree with a small anisotropy index.

Both degree of polarization and anisotropy index can indicate the degree of fiber formation of a meet analog, but the latter gives a better description and correlated better with actual fiber orientation. This is because the anisotropic index can compensate the effect of sample inhomogeneity. For inhomogeneous samples, sometimes, localized irregular regions can also produce relatively high P values. Samples of higher moisture content tend to be more affected by such inhomogeneous problem (as disclosed in the examples). However, if the sample has no dominant structural orientation overall, such localized irregular regions have randomized distribution. By rotating the incident polarization direction, similar P value can be obtained, which leads to a small anisotropic index.

According to the teaching of the invention, in addition to being an indicator of the degree of fiber formation, the anisotropic index can also be an indicator of the sample's inhomogeneity. When the sample is homogeneous with a dominant structural orientation, it will have a high degree of polarization and a high anisotropic index. If the sample is homogeneous with no dominant structural orientation, it will have a small degree of polarization and a small anisotropic index. If the sample is inhomogeneous with no dominant structural orientation, it may have a moderate polarization degree but with a small anisotropic index.

The teaching of the invention further discloses an inventive system to determine the degrees of fiber formation of meat analogs. The inventive system comprises (1) a sample holder holding a sample of a meat analog, (2) a fluorescence polarization spectrometer with two optical paths, where a first optical path starts with a excitation source, via means for polarizing excitation light, and ends with the sample, and a second optical path starts with the sample, via means for selecting polarized fluorescence light emitted from the sample, and ends with collection and detection means for determining intensities of fluorescence emission lights, (3) means for calculating polarization property of the sample, and (4) a pre-generated database collating polarization properties with degrees of fiber formation of the meat analog, which enables the comparison of the polarization measurement with the database to derive the degree of fiber formation.

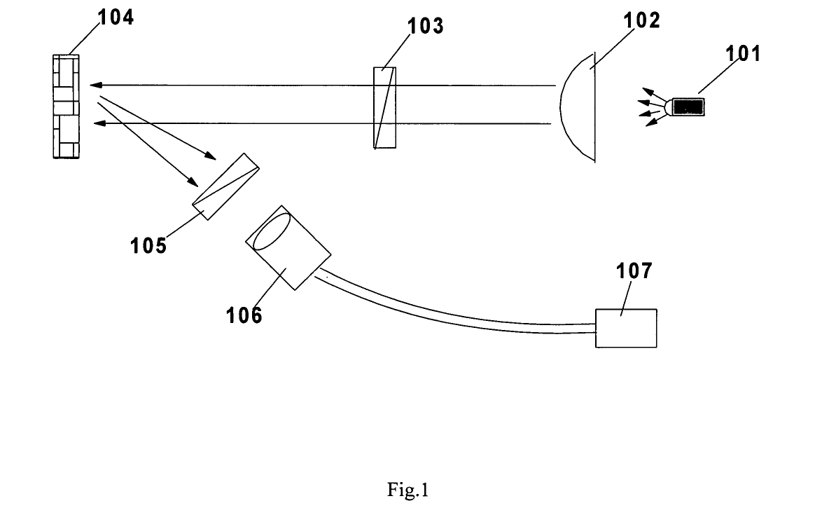

The invention teaches that any conventional fluorescence polarization spectrometer can be used in the inventive system in determining the degree of fiber formation of meat analogs. FIG. 1 is a schematic diagram of a fluorescence polarization spectrometer in one embodiment of the inventive system. As shown in FIG. 1, one embodiment of the inventive system comprises 1) an excitation source 101 for producing light to illuminate an area of a sample, 2) a coupling lens 102 to collimate the excitation light, 3) a first polarizer 103, as means for polarizing the excitation lights and located at a first optical path from the excitation source 101 to a sample, 4) a sample holder 104, 5) a second polarizer 105, located at a second optical path from the sample to a collection means 106 and as means for selecting a linear polarized fluorescence emission light, 6) collection means 106 to collect the fluorescence emission light, and 7) detection means 107 to measure the intensities of the fluorescence emission light.

In general, any ultraviolet light can be used as the excitation source 101, such as, a LED emits about 1 mW light at about 375 nm or any lasers or lamps with UV filter. Also, any spectrometer or detectors with appropriate filters, either single wavelength or multiple wavelengths, can be used as the detection means 107. In the particular example listed in the invention, the excitation light used peaks at about 375 nm, and the signal intensity at emission wavelength of about 540 nm is recorded and processed. The sample holder can be an individual sample holder generally used in a conventional fluorescence spectrometer, or a section of a production line, with an opening permeable by excitation and emission lights, in a meat analog extrusion process, if on-line detection is desired.

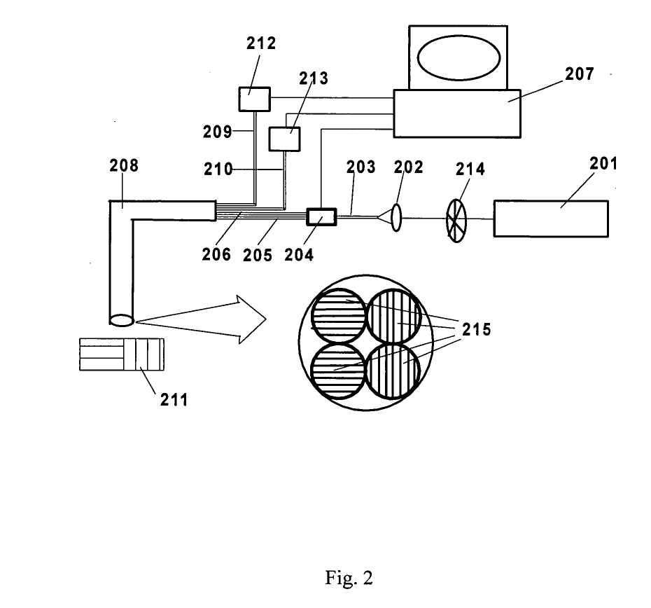

Another embodiment of the inventive system, an automated fluorescence polarization measuring system, is shown in FIG. 2. The automated system confines the excitation light and emission fluorescence light in four multimode optical fibers mounted inside an alumina tube, which enables online measurements on multiple sections of a meat analog production line. The automated system comprises 1) an excitation source 201, 2) a coupling lens 202 to couple the excitation light into a main input fiber 203, 3) the main input fiber 203, 4) a fiber switch 204, which connects with the main input fiber 203, is in electronic communication with a data control and analysis means 207, and under the directions of the date control and analysis means 207, switches between two incident fibers, 205 and 206, 5) two incident fibers 205 and 206, each representing different polarization states with about 90° relative geometry and as means for polarizing the excitation light 6) a housing tube 208 with two ends, which houses the two incident fibers and two collection fibers, 209 and 210, 7) two collection fibers, 209 and 210, each representing different polarization states with about 90° relative geometry and as means for selecting polarized fluorescence lights emitted from the sample 8) a sample holder 211 located at close vicinity but not direct contacting with one end of the housing tube 208, which allows polarized excitation lights illuminating at least a portion of the sample, and fluorescence emission lights being collected by the collection fibers, and 9) two detection means, 212 and 213, each connecting with one of the two collection fibers separately, measuring intensities of the corresponding fluorescence emission lights, and further in electronic communication with the data control and analysis means 207.

Generally, in an automated system, laser lights are used as the excitation source, and sometimes, a chopper 214, as shown in FIG. 2, is employed to modulate the laser lights before reaching the coupling lens 202. A personal computer is often used as the data control and analysis means 207. Micro-polarizing files 215, as shown in FIG. 2, can be glued upon the ends of the incident and collection fibers, so that different incident and detection polarization states can be achieved. During the measurement, the incident (excitation) light is switched alternatively by the fiber switch 204 into two incident fibers of different polarization states. The sample holder on an automated measuring system is generally a section of an extrusion production line with an opening permeable by excitation and emission lights.

The present invention also enables the automated and real-time determination of the degree of fiber formation of a particular meat analog. To achieve the real-time detection, the fluorescence polarization spectroscopic measuring system can be incorporated into a meat analog production line. To achieve automation in data analysis, a data base collating polarization properties index with degree of fiber formation for the meat analog needs to be established.

To establish the aforesaid database, the degree of fiber formation is to be defined numerically. Currently, the degrees of fiber formation are evaluated via visual inspections of either the actual samples or the images thereof. During visual inspections, the degrees of fiber formation are either loosely categorized as good, poor or none, or assigned a series of numeric index artificially. The soy protein meat analog described in the examples below (Ex. 1 and 2) have been loosely categorized as good, poor, and none.

The present invention also provides a new objective method for characterizing the degrees of fiber formation through an image processing technique based on Hough transform. The Hough transform has been recognized as one of the best method for detecting lines and curves in discrete image (Hough PVC, U.S. Pat. No. 3,069,654). The teaching of the invention expends the Hough transform to analyze fibrous meat analog based on that “fibers” in a meat analog can be considered as oriented along one direction (the extrudate moving direction in the long cooling die), thus can be approximated as linear lines.

The inventive method based on image processing comprises the steps of (1) preparing a sample of a target meat analog to reveal its fibrous structures, (2) obtaining an original image of the sample, (3) applying edge detection to the original image to product a second binary image with enhanced contrast, (4) performing Hough transform on the second image to extract line information and generate a third image, (5) defining a region of interest (ROI) within the third image, and (6) calculating the fiber index (FI, i.e. degree of fiber formation) via analysis of relative standard deviation of the ROI.

Sample preparation can be performed in many ways. The almost common method is dissection by hand peeling along the direction of the sample's fiber orientation to reveal the fibrous structures. Original image acquisition can also be achieved through many ways.

Various edge detection schemes can be applied to the original image. In the examples disclosed later, a standard gradient edge detection scheme is applied; pixel values are scaled to [0, 1]; and a global threshold is applied to convert the image to binary image. One of the critical criteria for effective edge detection is the threshold selection. Many threshold selection methods are available, but not all of them are suitable for every application. Fixed global threshold method, which uses a single fixed threshold value to classify image pixels from background, is commonly used in image processing and best suited for the inventive method.

In Hough transform, all pixels in a line segment of the second image are transformed to a corresponding single point in a Hough space. Each point in the parametric space votes for all pixels in a line. A straight line can be described in following parametric equation.
ρ=x cos θ+y sin θ (3)
Values of x and y in the second image are transformed into parametric space (ρ, θ) using the above equation. The pixels (x, y) close to the center are sampled more than the pixels away from the center because of their non-uniform distributions in the parametric space. To overcome this effect, the inventive method normalized each final accumulator value by the total possible values that can be accumulated in that particular point in parametric space. It worth noting that this procedure may provide heavily weighted phantom votes at the boundaries in parametric space depending on the intensity distribution of the boundaries in the original image.

While in standard Hough transform, θ in parametric space is defined from −90° to 90°, for better visualization and easy calculation process, the inventive method shifts parameter space by 90° to move the ROI to the center of the parameter space. The teaching of the invention reasons that “fiber” in a meat analog is oriented almost horizontally in the image so that the interested area is always closer to ±90°.

If a sample has good fiber formations, the original images have alternative high and low intensity regions in much uniform manner. For samples with poor fibrous structures, the band structures are not significant in the raw images. When these images are Hough transformed, the alternative high and low intensity regions are aligned along the ρ direction, which led to a highly varying gradient distribution in the parametric space. To characterize this effect, the inventive method uses gradient edge detection on Hough-transformed images and standardizes the grey levels between 0 and 1. When a higher gradient value is present, the image pixel at that point acquires a higher value. The inventive method uses fixed histogram percentage as global threshold for edge detected images to extract high gradient values.

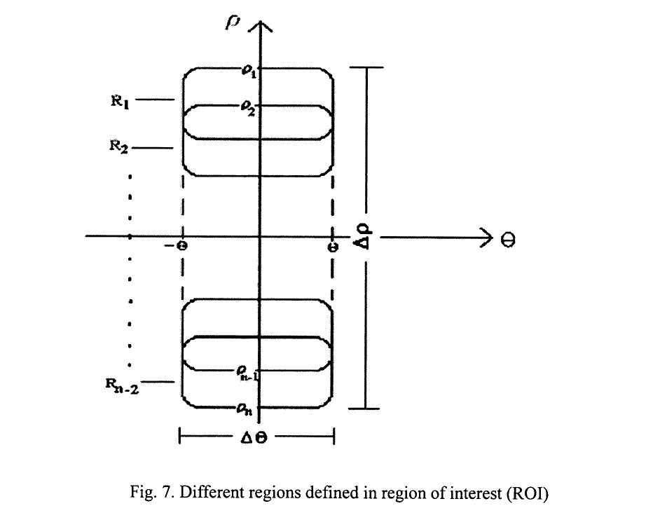

Because the sample's fiber orientation is aligned with the extrudate moving direction and images are also captured similar to that direction, the inventive method define a rectangular ROI from edge detected image depending on ρ and θ values in the Hough space. In the ROI, the width is equal to the angle difference, Δθ(−θ to θ); and the height is equal to Δρ, which can be divided into similar size rectangular regions, R₁, R₂ . . . Rn. The area of ROI region is equal to Δθ×(ρᵢ₊₂−ρᵢ), as shown in FIG. 7.

When intensity of the pixel is represented by Z(ρ,θ), Tᵢ provides the sum of all the pixels in the region Rᵢ:

$${T}_{i} = {\sum }_{{ρ}_{i}}^{{ρ}_{i} + 2} {\sum }_{- θ}^{θ} Z ( ρ , θ ) . \qquad ( 4 )$$

where i=1, 2 . . . , n−2. When more “high” pixels are present in all regions, the mean value of the regions μ(R) is higher. The standard deviation of all regions σ(R) estimates the intensity distribution among these regions. A fiber index (FI) is calculated as an inverse of the relative standard deviation (ratio of standard deviation and mean value) of all regions.

$$FI = \frac{1}{Relative Std . Deviation} = \frac{μ ( R )}{σ ( R )} \qquad ( 5 )$$

When fiber distribution is uniform, the relative standard deviation provides a lower value; and when distribution is non-uniform, relative standard deviation provides a higher value.

Having described the invention, the following examples are given to illustrate specific applications of the invention including the best mode now known to perform the invention. These specific examples are not intended to limit the scope of the invention described in this application.

### EXAMPLE 1

Determination of degrees of fiber formation of meat analog samples with different moisture contents:

Materials: Soy protein isolate (Profam 974) was obtained from ADM (Decatur, Ill.); wheat gluten and unmodified wheat starch (Midsol 50) was from MGP Ingredients, Inc. (Atchison, Kans.). These raw ingredients were blended at a ratio of 6:4:0.5, using an 18.9 L Hobart Mixer for 30 min to ensure the uniformity of the feeding material.

Extrusion: Extrusion was performed using a pilot-scale, co-rotating, intermeshing, twin-screw food extruder (MPF 50/25, APV Baker Inc., Grand Rapids, Mich.) with a smooth barrel and a length/diameter ratio of 15:1. The clamshell style barrel is segmented into five temperature-controlled zones that are heated by an electric cartridge heating system and cooled with water. The barrel can be split horizontally and opened to enable rapid removal and cleaning of the barrel and the screws. The screws are built with screw elements and lobe-shaped paddles, which can be assembled on hexagon-shaped shafts to give different screw geometries. The screw profile comprised of (from feed to exit): 100 mm, twin lead feed screw; 50 mm, 30° forwarding paddles; 100 mm, single lead screw; 87.5 mm, forwarding paddles; 175 mm, single lead screw; 87.5 mm, forwarding paddles; 50 mm, 30° reversing paddles; and 100 mm, single lead screw.

A K-tron type T-35 twin screw volumetric feeder (K-tron Corp, Pitman, N.J.) was used to feed the raw materials into the extruder at a feeding rate of 12 kg/h. While operating, water at ambient temperature was injected, via an inlet port, into the extruder by a positive displacement pump with a 12 mm head. The inlet port was located on the top of the barrel, 0.108 m downstream from the feeding port. The pump was pre-calibrated and adjusted so that the extrudate moisture content would vary from 60 to 72%. The screw speed was set at 125 rpm. At the end of the extruder, a long cooling die was attached, with a dimension of 60×10×300 mm (W×H×L). Cold water (5° C.) was used as the cooling medium for the die. The extruder barrel temperatures were set at 25, 36, 100, 155, and 170° C. from the first (feeding zone) to the fifth zone, respectively. The extruder responses, including the die pressure, the percent torque, and the product temperature before the cooling die, were recorded. Two sets of samples, 5 kg each, were collected for each treatment and immediately put into airtight plastic bags. One set was stored in a refrigerator at 4° C. and the other in a freezer at −18° C. The refrigerated samples were used for measurement and analysis within 48 hours. The frozen samples were intended to be used only as backup in case the refrigerated samples were run out, which was not the case in this study.

Moisture and texture measurements: Sample moisture contents were determined by the official AOAC method, with minor modification, using a vacuum oven (AOAC 2000). The texture profile analysis was conducted using a TA.XT2 analyzer following the method of Lin and others (2000). A cylindrical probe (25.4 mm in diameter) was used for the test and a metal puncher was used to obtain cylindrical testing samples (about 10 mm in both diameter and thickness). Samples were compressed to 50% of their initial thickness. Five attributes were recorded: springiness, cohesiveness, gumminess, chewiness and hardness. Data from 5 pieces of each treatment were collected and used in the analysis.

Visual examination and image recording by a digital camera: Samples were dissected by hand peeling along the direction of fiber orientation. The dissected samples were examined visually for the degree of fiber formation. Their images were also taken by a high-resolution camera attached to a computer, and recorded digitally.

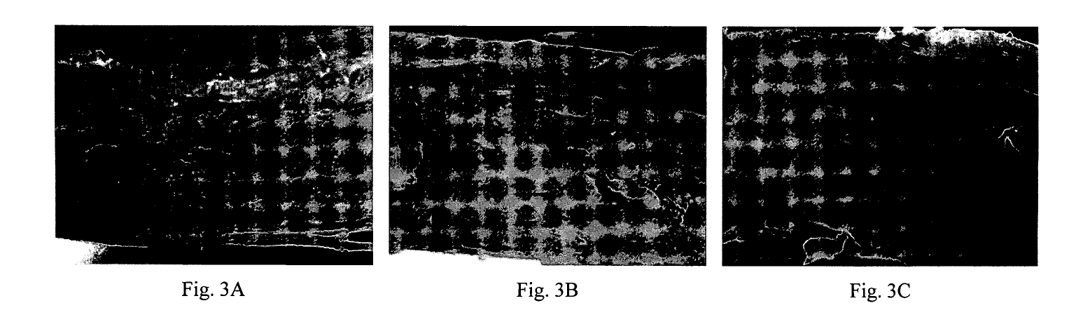

The corresponding digital images are shown in FIGS. 3A to 3C, where FIG. 3A is the digital image of extruded protein products at 60.11% moisture, FIG. 3B 66.78%, and FIG. 3C 72.12%. All images were approximately 1.9×1.4 cm (W×H) in size. Among three samples extruded under various levels of moisture contents while keeping other extrusion conditions the same, the one extruded at 60.11% (w.b.) showed the best and well-defined fiber orientation, which was assigned a degree of fiber formation as good. As the moisture content increased from 60.11 to 72.12%, the fiber formation became less defined. Degrees of fiber formation for 66.68% and 72.12% were assigned as poor, with the one at 66.68% slightly better than the one at 72.12%.

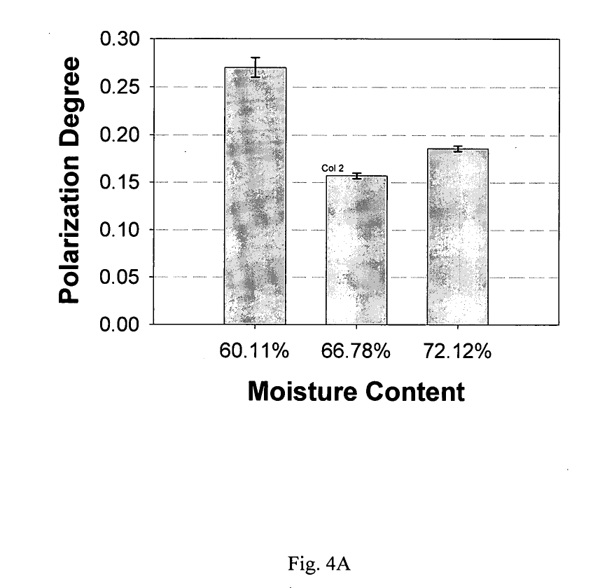

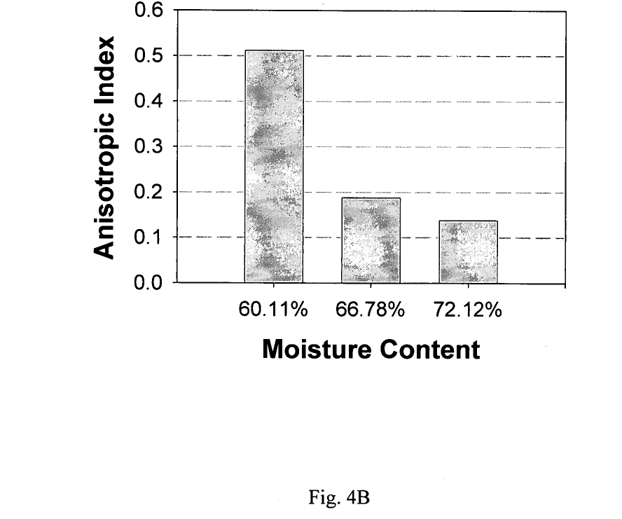

Polarization Degree measurements performed using the inventive method: FIGS. 4A and 4B show the degree of polarization (P value) and the anisotropic index (N index) of extruded samples at different moisture contents, respectively. Multiple measurements at different sample sites were performed to calculate the degree of polarization. The anisotropic index was calculated from two P values measured with two orthogonal incident polarization states (Eq. 2). Table 1 lists the P values and N indexes at different moisture Content and their collating assignments on degrees of fiber formation.

TABLE 1
P values/N indexes and Degree of fiber formation at different moisture
contents

| Moisture Content | P value | N index | Degree of fiber formation |
|---|---|---|---|
| 60.11% | 0.27 | 0.51 | Good |
| 66.78% | 0.16 | 0.19 | Poor |
| 72.12% | 0.19 | 0.14 | Poor |

The results indicate that the sample at 60.11% moisture content with good fiber formation has a much higher degree of polarization and anisotropic index than samples at higher moisture contents. This agrees very well with the imaging results and visual examination. Furthermore, the anisotropic index appeared to be a more superior indicator of the fiber formation than the polarization degree. The anisotropic index not only shows greater differences among samples with different degrees of fiber formation, but also predicts more reliable degrees of fiber formation in consistence with the recorded image and visual examination. Comparing degrees of polarization alone may produce erroneous results, such as the erroneous result shows here: the P value at 72.12% moisture contents is slightly higher than those at 66.78% moisture contents, whereas comparing FIGS. 3B and 3C, the later has slightly better fiber formation than the former.

### EXAMPLE 2

Determination of degrees of fiber formation of meat analog samples at different production stages: (Materials and extrusion procedure are the same as those in Example 1.)

One dead-stop extrusion run was conducted at the end of a run at the moisture level of 60.11%. At this moisture, products with well-defined fibrous structures were produced under the described extrusion conditions. The extrusion operation was intentionally shut down (dead-stop) after reaching steady state. The barrel was cooled using the maximum cooling capacity and opened immediately, and samples along the extruder barrel at each of the five zones and the cooling die and the extruded product, were collected. The sample from Zone 1 corresponded to the raw mixture. Zone 5 was the last zone adjacent to the cooling die.

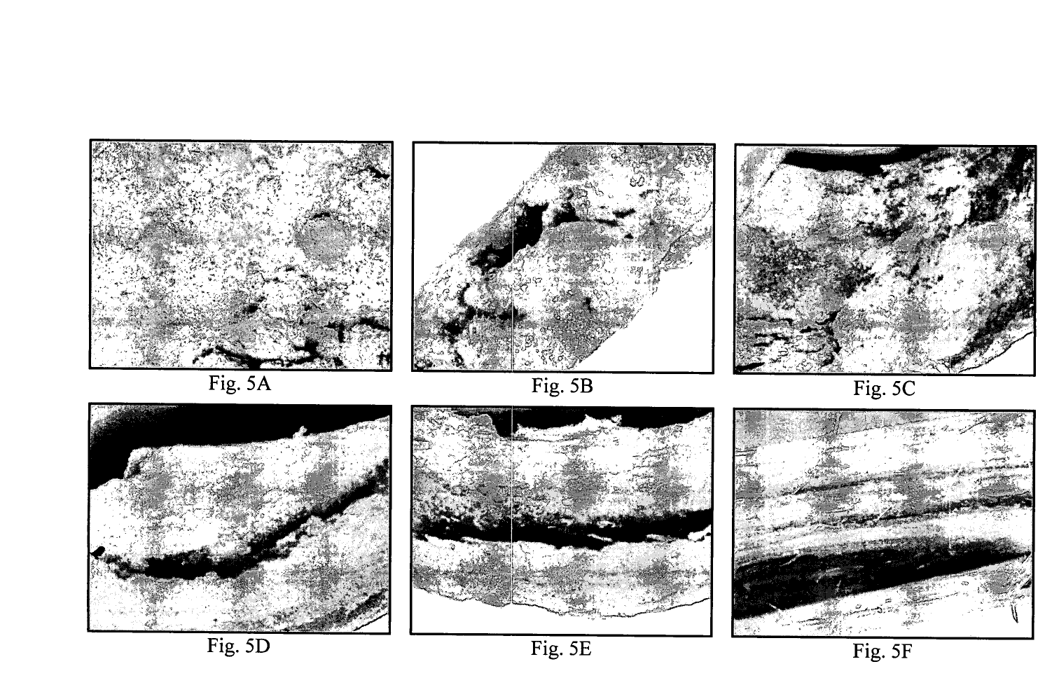

Determining fiber formation by visual examination and digital imaging: Visual examinations were performed on peeled/dissected samples of different stages in the dead-stop extrusion run. FIGS. 5A to 5F are the corresponding digital images of proteinaceous samples collected in different stages in the dead-stop run, where FIG. 5A is for the sample collected in Zone 1, FIG. 5B for Zone 2, FIG. 5C for Zone 3, FIG. 5D for Zone 4, FIG. 5E for Zone 5, and FIG. 5F for Die. Based on the digital images and visual examinations, for sample obtained during the dead-stop run at 60.11% moisture content, fiber formation did not occur until the last zone of the extruder barrel (Zone 5). Thus, the degrees of fiber formation are assigned as following: None for Zone 1 to Zone 4, Poor for Zone 5, and Good for Die. It is interesting to note that the sample collected from the cooling die had the best fiber orientation by visual examination, which indicates that the extended cooling after dead-stop operation might help continue the fiber formation process.

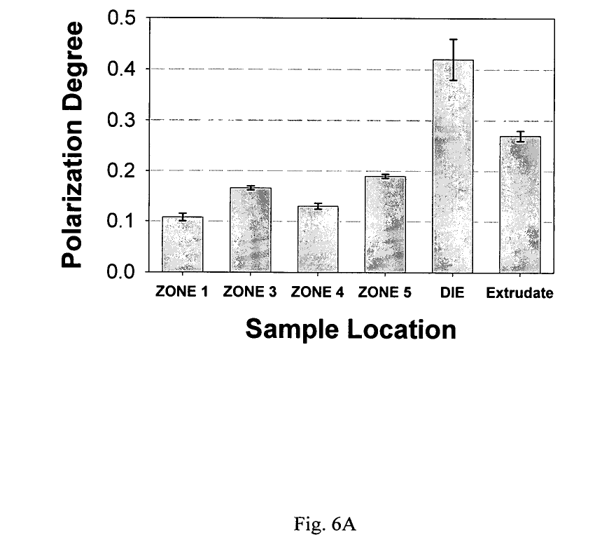

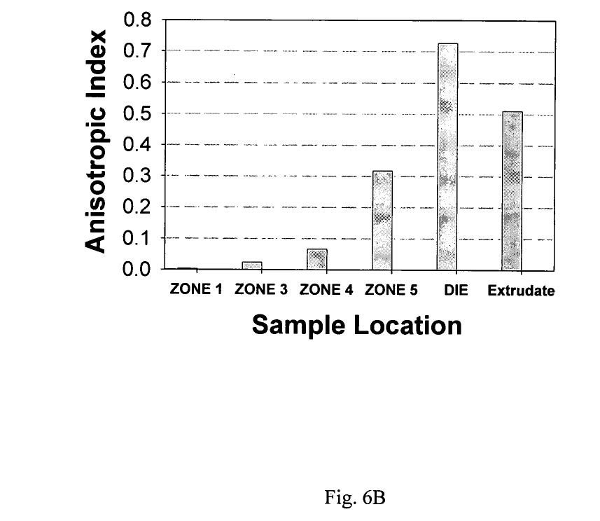

Determining fiber formation by the inventive methods: P values and N indexes were measured on samples obtained from the dead-stop operation using the inventive methods. FIG. 6A shows the degrees of polarization (P value) of samples at the different zones and the die, while FIG. 6B shows the Anisotropic Index (N) of samples at the different zones and the die. Table 2 lists the P values and N indexes at different production stages and their collating assignments on degrees of fiber formation.

TABLE 2
P values/N indexes and Degrees of fiber formation at difference
production stages.

| Production stage | P value | N index | Degree of fiber formation |
|---|---|---|---|
| Zone 1 | 0.11 | 0.003 | None |
| Zone 2 | N/A | N/A | None |
| Zone 3 | 0.17 | 0.024 | None |
| Zone 4 | 0.13 | 0.067 | None |
| Zone 5 | 0.19 | 0.317 | Poor |
| Die | 0.42 | 0.727 | Good |

The results clearly indicate that the cooling die sample has the best fibrous structure. According to the anisotropic index measurements, the fiber formation was started at Zone 5, which is in agreement with the results from visual inspection and digital imaging described above. Comparing FIG. 6A and FIG. 6B also confirms that the anisotropic index is a better indicator than the degree of polarization.

Combining the results in Table 1 and 2, a loosely defined database collating P values and N indexes with degrees of fiber formation for the meat analog used in the examples can be compiled. The loosely defined database is shown in Table 3.

TABLE 3
Degrees of fiber formation database for the meat analog used in the
examples.

| Degree of Fiber Formation | P value | N index |
|---|---|---|
| Good | >0.20 | >0.50 |
| Poor | ˜0.15 to ˜0.20 | ˜0.10 to ˜0.50 |
| Poor | <0.15 | <0.10 |

### EXAMPLE 3

Characterization of degrees of fiber formation of meat analog sample at different production stages via imaging process (Materials and extrusion procedure are the same as those in Example 1.)

The inventive imaging processing method has been applied on two meat analog sample (both are extrusion products using soy protein isolate mixture with 60.11% moisture content) at different production stages. Sample A is the end product with good fiber formation. Sample B is the intermediate product in early zone (Zone 2-5) with none or poor fiber formation. Samples A and B are dissected by hand peeling, and their images are acquired by a video camera (Pulnix, TM-7EX, Sunnyvale, Calif.) attached to a computer.

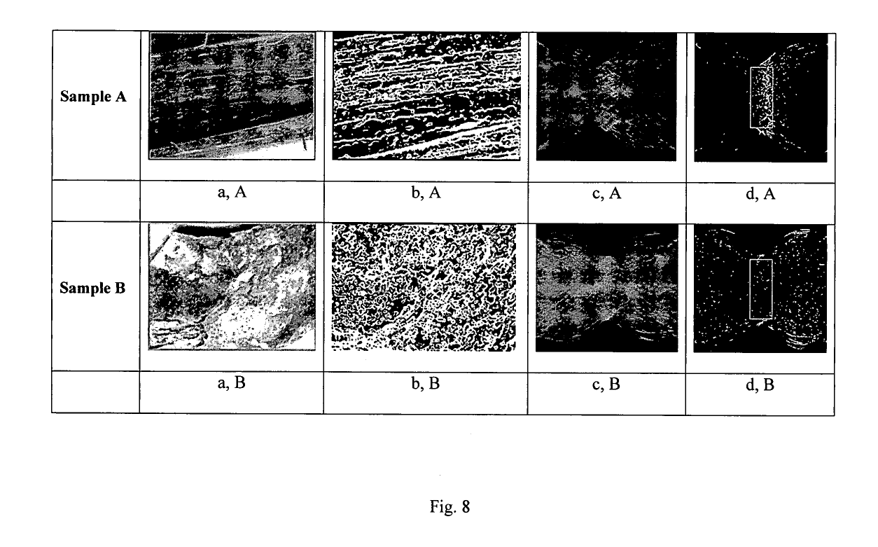

FIG. 8 shows the image processing for Samples A and B. With FIGS. 8, 8(a, A) and 8(a, B) are the original images; 8(b, A) and 8(b, B) are the second images, i.e. the images after edge detection; 8(c, A) and 8(c, B) are images after Hough transform, the third images; and 8(d, A) and 8(d, B) show the calculations and areas of ROI. All images are approximately 1.9 cm×1.4 cm and saved as 320×240 grey scale images. The images are cropped to 280×180 to remove excessive background and a standard 3×3 Sobel edge detection is applied. A global threshold of 9.4% of the maximum grey scale is then applied to convert the image into a binary image. It can be seen from FIG. 8(b, A) that the fibrous structures are preserved in the forms of lines for sample A; while the image is noisy and irregular for sample B, as shown in FIG. 8(b,B).

Hough transform is then performed on the second binary images. Due to those binary lines in sample A, there are high intensity pixels presented in the regions around 90° in Hough space. On the contrary, sample B is rather uniform in the whole Hough space. Sobel gradient edge detector is again applied to the Hough transformed images to yield FIGS. 8(c, A) and 8(c, B). To detect the high gradients, only high intensity pixels which are located in the right most part of the histogram of the edge detected image should be analyzed. A threshold is set to extract pixels with intensities above 98% of image histogram. As a result of a heavy contribution of “high” values next to the top and bottom boundary of edge detected original image, high gradient distribution can be seen in the parametric space boundaries. Contribution of these boundary values deviates considerably from the outcome of the proposed method. Therefore, Δρ is selected as 160 (−80 to 80) to exclude the boundaries.

After analyzing gradient distribution of large number of well oriented fiber samples, Δθ of the ROI is selected as 30° (−15° to 15°). For better statistical analysis, number of regions can be increased by breaking down ROI into small regions. However, each region should contain sufficient data to reflect the information in parametric space distribution. When height of the region (ρᵢ₊₂−ρᵢ) equals to 20, distribution of Tᵢ highly represents the data distribution along the ρ direction. Further, the number of regions can be increased for statistical analysis by overlapping regions. Overlapping half of the other region not only doubled the number of regions for analysis but also improved the final results considerably. Because overlapping is equivalent to smooth filter, extreme overlapping regions provided unreliable results. After ROI regions are selected, sum of all binary values in each ROI region is stored in a one dimensional array for statistical analysis.

FI values are calculated using inverse of the relative standard deviation according to Eq. 5. For Sample A, FI is 5.9; for Sample B, FI is 1.7. The FI values further prove that samples (in this case, Sample A) with good fiber formation with high average intensity and low standard deviation, which leads to a higher fiber index.

### EXAMPLE 4

Establishment of a database collating polarization properties with degrees of fiber formation (FI) of a particular meat analog (soy protein):

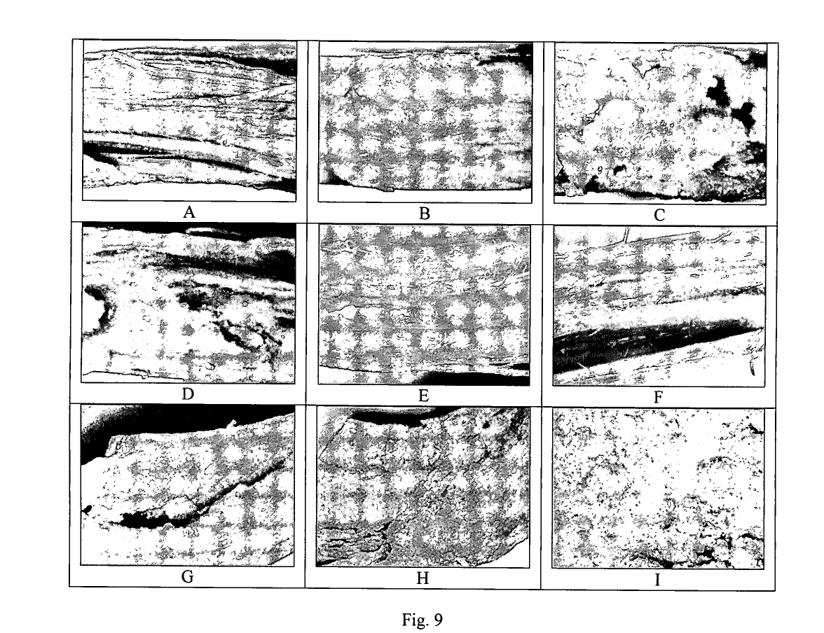

A collation (i.e. a database) between the calculated fiber index (FI) and the P value measurements using fluorescence polarization spectroscopy on nine extrusion samples has been established. The original images are shown in FIGS. 9A to 9I. Images A to C represent extrusion products using a combination of soy protein isolate and whey protein concentrate with concentration ratio of 3:2. The barrel temperature was 160° C. and moisture contents were 60(A), 65(B), and 70% (C) wb. Images D and E represent extrusion products using mixture of Soy protein isolate, wheat gluten and unmodified wheat starch at a ratio of 6:4:0.5. The corresponding moisture contents were 66.78% (D) and 60.11% (E), respectively. Images F to I present samples collected at different extruder barrel stages during a dead-stop run when producing sample E. They were collected from die area (F), Zone-4(G), Zone-3(H), and Zone-1(I).

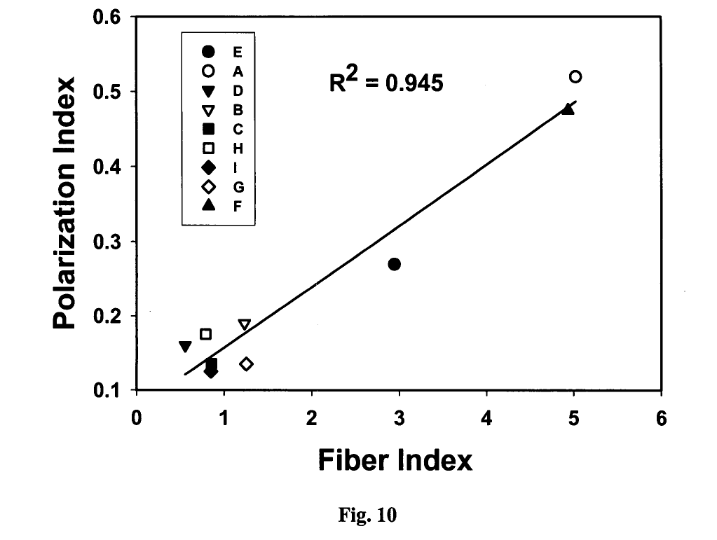

The correlation between P values and degrees of fiber formation (FI) is plotted in FIG. 10. FIG. 10 shows that the non-destructive fluorescence polarization measurements correlate highly with the objective imaging processing calculations.

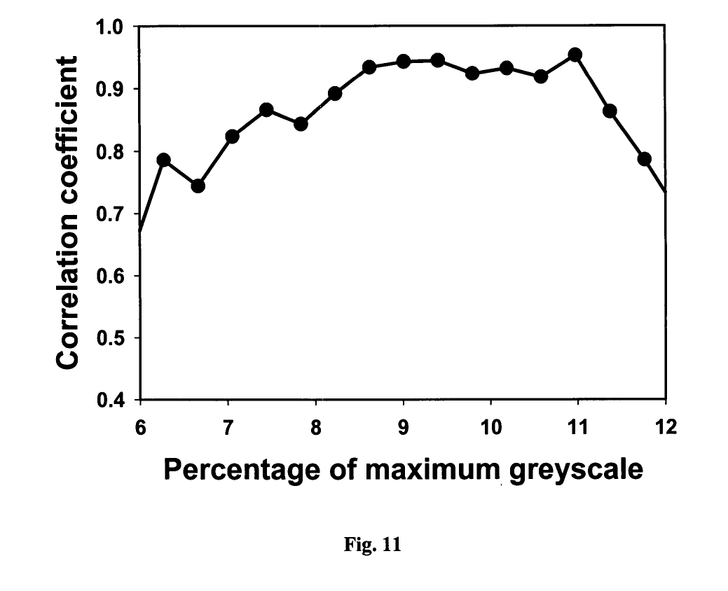

Fixed global threshold method is used in the example and provides consistent and stable results for thresholding edge detected original image. Threshold selection depends on various factors, such as ambient illumination, busyness of gray levels within the object and its background, inadequate contrast, and object size. When all environmental conditions are constant, fixed global threshold can be used without any change. In fact, any fixed threshold values from 8.5% to 11% of the maximum grey scale provided higher than 0.9 of correlation coefficient with fluorescence polarization data (FIG. 11).

Histogram percentage technique is the other often used thresholding algorithm, in which the threshold value is chosen as the grey level corresponding to the intensity percentage of the histogram. Threshold of 98% of histogram percentile is chosen for Hough transformed images in this study. However, any threshold value providing 70%-99.4% of histogram percentage achieved correlation coefficient above 0.8 with fluorescence measurements.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features herein before set forth and as follows in scope of the appended claims.

1. A method for determining degree of fiber formation of a meat analog comprises the steps of:
(a) selecting a sample of a meat analog,
(b) using fluorescence polarization spectroscopy to measure polarization property of the sample, and
(c) determining degree of fiber formation of the sample by comparing the measurement with a pre-generated data base collating polarization properties and degrees of fiber formation for the meat analog.

2. The method as claimed in claim 1 wherein said fluorescence polarization spectroscopy using step further comprising the steps of:
(a) illuminating at least a portion of the sample with light of a first wavelength via a means for polarizing light (P1),
(b) measuring a first intensity (I₉₀) of fluorescence emitted at a second wavelength via a means for selecting polarized fluorescence emission light for detection (P2), when P2 is at 90° with P1,
(c) measuring a second intensity (I₀) of fluorescence emitted at the second wavelength via P2, when P2 is at 0° with P1, and
(d) calculating the degree of polarization (P) as
$$P = \frac{\vert {I}_{0} - {I}_{90} \vert}{{I}_{0} + {I}_{90}} .$$

3. The method as claimed in claim 2 wherein said first and second wavelengths are about 375 nm and about 540 nm, respectively.

4. The method as claimed in claim 1 wherein said fluorescence polarization spectroscopy using step further comprising the steps of:
(a) illuminating at least a portion of the sample with light of a first wavelength via a means for polarizing light (P1) at a first angle;
(b) measuring a first intensity (I_{90,0}) of fluorescence emitted at a second wavelength via a means for selecting polarized fluorescence emission light for detection (P2), when P2 is at 90° with P1;
(c) measuring a second intensity (I_{0,0}) of fluorescence emitted at the second wavelength via P2, when P2 is at 0° with P1;
(d) calculating the degree of polarization (P₀) as
$$P = \frac{\vert {I}_{0} - {I}_{90} \vert}{{I}_{0} + {I}_{90}} ;$$
(e) illuminating at least a portion of the sample with light of the first wavelength via P1 at a second angle at 90° with the first angle;
(f) measuring a third intensity (I_{90, 90}) of fluorescence emitted at the second wavelength via P2, when P2 is at 90° with P1;
(g) measuring a second intensity (I_{0,90}) of fluorescence emitted at the second wavelength via P2, when P2 is at 0° with P1;
(h) calculating the degree of polarization (P₉₀) as
$$P = \frac{\vert {I}_{0} - {I}_{90} \vert}{{I}_{0} + {I}_{90}} ,$$
(i) calculating the anisotropy index (N) as:
$$N = \frac{\vert {P}_{90} - {P}_{0} \vert}{( {P}_{90} + {P}_{0} ) / 2} .$$

5. The method as claimed in claim 4 wherein said first and second wavelengths are about 375 nm and about 540 nm, respectively.

6. A method for determining degree of fiber formation of a meat analog comprises the steps of:
(a) preparing a sample of the meat analog to reveal its fibrous structures;
(b) obtaining an original image of the sample;
(c) applying edge detection to the original image to product a second binary image with enhanced contrast;
(d) performing Hough transform to extract line information of the second image and generate a third image;
(e) defining a region of interest (ROI) within the third image ; and
(f) calculating the fiber index (FI, i.e. degree of fiber formation) via analysis of the relative standard deviation of the ROI.

7. A system for determining degree of fiber formation of a meat analog comprising:
b. a sample holder holding a sample of a meat analog;
c. a fluorescence polarization spectrometer, which comprises
(i) an excitation source for illuminating a least a portion of a sample of a meat analog with light of a first wavelength
(ii) a means for polarizing excitation light (P1), through which light of the first wavelength illuminates the sample,
(iii) a means for selecting fluorescence light emitted from the sample (P2),
(iv) collecting and detecting means for measuring intensities of polarized fluorescence at a second wavelength emitted from the sample,
d. means for determining the degree of polarization (P value) and/or anisotropy index (N index) of the sample, and
e. a pre-generated database collating P values and/or N-index with degrees of fiber formation of the meat analog, which enables the comparison of the resulting P value and/or N index with the database to derive the degree of fiber formation.
